(19) United States
(12) Patent Application Publication
(10) Pub. No.: US 2012/0247395 A1
(43) Pub. Date: Oct. 4, 2012

(54) RESTRAINING FISH TANK AND USES THEREOF

(76) Inventors: Wade Koba, Ossining, NY (US); Eugene J. Fine, East Hampton, NY (US)

(21) Appl. No.: 13/505,291

(22) PCT Filed: Nov. 2, 2010
(86) PCT No.: PCT/US10/02882

§ 371 Date: Jun. 13, 2012

Related U.S. Application Data
(60) Provisional application No. 61/280,917, filed on Nov. 10, 2009.

(51) Int. Cl. A01K 63/04; A01K 63/00

(52) U.S. Cl. 119/207; 119/228; 119/234; 119/200

(57) ABSTRACT

The present invention provides a device for immobilizing aquatic animals, the device comprising a receptacle for holding an aquatic animal in a volume of water, an opening in the receptacle for placement and removal of the aquatic animal, a restraint positioned inside the receptacle for restraining the aquatic animal, and a tube attached to the receptacle for supplying air or aerated water to the receptacle. The present invention further provides methods of immobilizing and imaging live aquatic animals using the device of the present invention.

### CROSS-REFERENCE TO RELATED APPLICATION

This application claims the benefit of U.S. Provisional Patent Application No. 61/280,917, filed Nov. 10, 2009, the content of which is hereby incorporated by reference into the subject application.

### FIELD OF THE INVENTION

The present invention relates to the field of non-invasive translational imaging of aquatic animals.

### BACKGROUND OF THE INVENTION

The last several years have shown explosive growth in translational imaging as an essential tool in the advancement of biomedical knowledge. The National Institutes of Health (NIH) has made translational imaging a priority for research because longitudinal non-invasive, quantitative imaging permits improved scientific benefit using animals as their own controls, while simultaneously reducing animal sacrifice. Additionally, there has been substantial commercial growth of pre-clinical imaging divisions within major diagnostic imaging corporations. It is estimated that there will be 4,040 installed pre-clinical imaging units as of 2009, with an estimated 6,700 by 2012.

In order to image aquatic animals without animal sacrifice, the animals must be both restrained for imaging and provided with life support. Previous devices do not limit the movement of the animal, requiring injection of paralytic agents or anesthetics. The natural physiologic state of the animal may not be readily detected once the paralytic agents or anesthetics have been administered. No method has yet been devised that permits aquatic animal imaging with Positron Emission Tomography (PET), Single Photon Emission Tomography (SPECT), computed tomography (CT), optical or other in vivo imaging device such as sonography or photoacoustic spectroscopy. In addition, Magnetic Resonance Imaging (MRI) that has been performed in aquatic animals has been limited to short duration imaging with the animals packed in Hydrogel around the gills, a non-physiologic environment. Additionally, Hydrogel is known to work for freshwater fish only.

The present invention overcomes these problems, allowing for more accurate imaging of aquatic animals in their natural physiologic states. Additionally, the present invention allows for the use of PET, SPECT, CT or MRI methods in freshwater, brackish water, and saltwater aquatic animals.

### SUMMARY OF THE INVENTION

The present invention provides a device for immobilizing aquatic animals, the device comprising a receptacle for holding an aquatic animal in a volume of water, an opening in the receptacle for placement and removal of the aquatic animal, a restraint positioned inside the receptacle for restraining the aquatic animal, and a tube attached to the receptacle for supplying air or aerated water to the receptacle.

The present invention also provides a method for immobilizing a live aquatic animal comprising placing an aquatic animal in a device comprising a receptacle for holding an aquatic animal in a volume of water, wherein the device comprises an opening in the receptacle for placement and removal of the aquatic animal, a restraint positioned inside the receptacle for limiting movement of the aquatic animal, and a tube attached to the receptacle for supplying air or aerated water to the receptacle; and positioning the restraint inside the receptacle to limit the movement of the aquatic animal.

The present invention further provides a method for imaging a live aquatic animal, the method comprising placing an aquatic animal in a device comprising a receptacle for holding an aquatic animal in a volume of water, wherein the device comprises an opening in the receptacle for placement and removal of the aquatic animal, a restraint positioned inside the receptacle for limiting the movement of the aquatic animal, and a tube attached to the receptacle for supplying air or aerated water to the receptacle; positioning the restraint inside the receptacle to limit the movement of the aquatic animal; and imaging the aquatic animal.

### BRIEF DESCRIPTION OF THE DRAWINGS

FIG. 1. Schematic of a preferred embodiment of the invention. A tube [1] for supply of air or aerated water is attached to a receptacle [2] capable of holding an aquatic animal in water. A restraint [3] is positioned within the receptacle to limit movement of the aquatic animal. A gas relief spout [4] allows for the equalization of excess water or gas pressure. The receptacle's opening has a closure [5] which seals the opening and which, in the preferred embodiment, can move laterally.

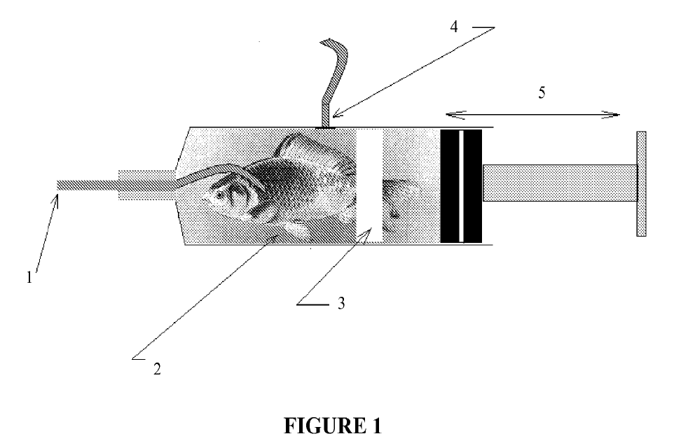

FIG. 2. Schematic of a preferred embodiment of the invention showing a physiological intervention port [7] positioned in the tube [1] for supply of aerated water and a tube [6] leading from the gas relief spout to an overflow bucket. The receptacle has a collar [8] for tilting the receptacle [2] to facilitate evacuation of gas through the gas relief spout.

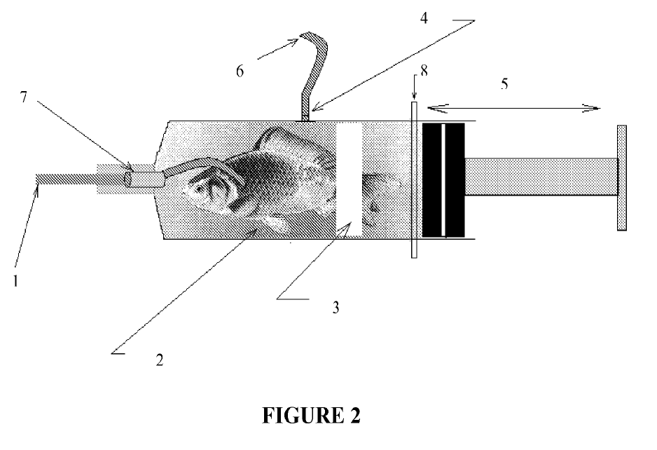

FIG. 3. Schematic of a preferred embodiment of the invention showing the capacitor [9] between metal strips [10] surrounding the receptacle [2]. The metal strips can serve as coils for MRI imaging.

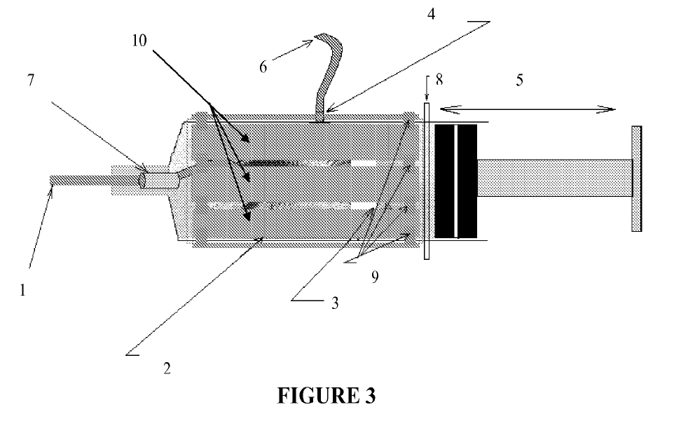

FIG. 4. Schematic of a preferred embodiment of the invention. Shown is a bite plate\textcircled{1}, which protects the supply line\textcircled{2} so that oxygen delivery to the gills is not compromised. The supply line is bifurcated so that oxygen can be supplied to both gills simultaneously. A spout\textcircled{3} for relief of gas or water is positioned through the lateral moving seal. The seal can be rotated so that the spout is positioned on the bottom of the receptacle to facilitate removal of waste from the receptacle.

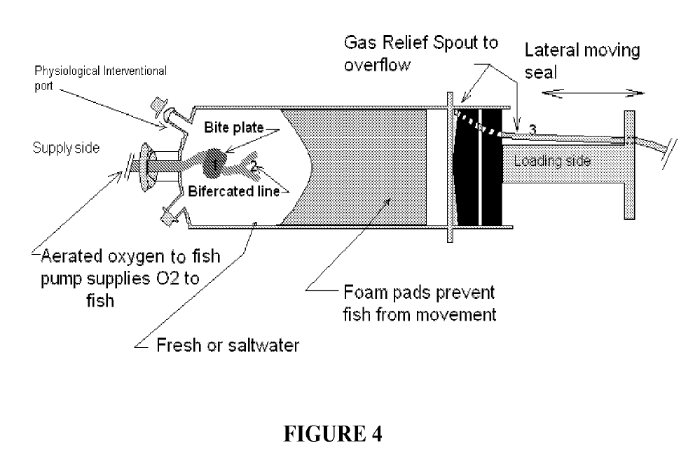

FIG. 5. Schematic of a preferred embodiment of the invention showing metal coils that can be used for MRI imaging.

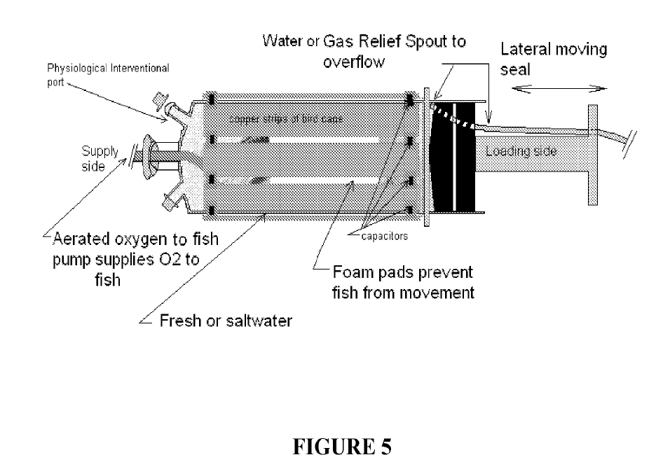

### DETAILED DESCRIPTION OF THE INVENTION

The present invention provides a device for immobilizing aquatic animals, the device comprising a receptacle for holding an aquatic animal in a volume of water, an opening in the receptacle for placement and removal of the aquatic animal, a restraint positioned inside the receptacle for limiting movement of the aquatic animal, and a tube attached to the receptacle for supplying air or aerated water to the receptacle.

The receptacle [2] is large enough to hold an aquatic animal in an amount of water. Preferably, the receptacle holds an aquatic animal in only a limited amount of water in order to limit imaging artifacts caused by the presence of water. The receptacle can be made out of any low-density material known in the art which is transparent to the method of imaging being used. For example, the receptacle can be made out of low-density material which is transparent to electromagnetic (EM) radiation in the visual range, the radiofrequency (RF) range, and the high energy range of X-rays and gamma rays. The receptacle may have a collar [8] positioned at one end in order to tilt the receptacle to facilitate evacuation of gas through the gas relief spout.

The aquatic animal can be any animal, either vertebrate or invertebrate, which lives in the water for most or all of its life. In particular, the present invention is directed to aquatic animals which extract oxygen dissolved in water. The aquatic animal can be any fish, such as, for example, the Toad fish or zebra fish; any crustacean such as, for example, a horseshoe crab, fiddler crab, or crayfish; or any cephalopod such as, for example, a squid. The aquatic animal can also be an amphibian such as, for example, a frog or salamander. The aquatic animal can be an animal adapted to fresh water, seawater, or brackish water. Both brackish water and seawater are saltwater. Brackish water has more salinity than fresh water, but less than seawater, such as the water in estuaries.

Movement of the subject being imaged during the imaging process results in image artifacts. In order to minimize such artifacts, when the subject is an aquatic animal, the movement of the aquatic animal must be limited. However, when imaging the aquatic animal in its natural physiologic state, total immobilization, such as via paralyzation or anesthetization, is undesirable. In the present invention, limiting movement of the aquatic animal includes precluding the aquatic animal from its normal mode of locomotion.

In order to limit the aquatic animal's movement without the use of paralytic agents or anesthesia, a restraint [3] is located within the receptacle [2] which renders the animal immobile. When the aquatic animal is a fish, the restraint [3] can be placed against the lateral side of the fish from behind the gill slit to the caudal fin, preventing movement. When the aquatic animal is a crustacean or cephalopod, or any other aquatic animal, the restraint [3] can be positioned within the receptacle [2] so as to prevent movement. The restraint [3] can be made from any material known in the art, such as foam. Preferably, the restraint is strong enough to withstand repeated usage, yet does not cause damage to the aquatic animal being restrained. More preferably, the restraint is transparent to the method of imaging being used, to allow imaging of the entire aquatic animal. Most preferably, the restraint [3] is composed of one or more pieces, in order to allow for the restraint of various aquatic animals.

In order to allow for imaging of aquatic animals in their natural physiologic states over a prolonged time, a tube [1] is attached to the receptacle [2] to allow for the supply of air or aerated water to the aquatic animal within the receptacle. The tube can be used to deliver air or aerated water directly to the mouth of the animal. The tube can be bifurcated so that oxygen can be supplied to both gills or lungs simultaneously. The tube can be made of any material known in the art. Preferably, the tube is transparent to the method of imaging being used. A bite plate can be used to protect the tube so that oxygen delivery to the animal is not compromised. Since the aquatic animal can receive a constant supply of air or aerated water and can therefore remain within the present invention for lengthy periods of time with no ill effect, the present invention can be used for lengthy imaging studies. Alternatively, the present invention can be used to quarantine aquatic animals. In one embodiment, wax can be used to seal the opening through which the tube passes.

In some embodiments, the receptacle comprises a physiological intervention port [7]. This port can be part of the tube [1] complex allowing the supply of air or aerated water to the aquatic animal within the receptacle and/or the port can be a separate opening to the receptacle. This port allows introduction of fluids for nutritional or drug manipulation, electrodes for stimulation or monitoring, or optical monitoring scopes into the receptacle while the aquatic animal is within the receptacle. Nutritional or drug manipulation, stimulation or monitoring, or optical monitoring can occur before, during, or after imaging. Any electrode stimulation or monitoring known in the art may be accomplished, including gating, electrocardiography, and electroencephalography.

In some embodiments, the device further comprises a relief spout attached to the receptacle to allow the equalization of excess water or gas pressure. The relief spout [4] can be made out of any material known in the art. Preferably, the relief spout is transparent to the method of imaging being used. The relief spout [4] can lead into an overflow container [6] to catch water pushed out of the relief spout due to excess water or gas pressure in the receptacle [2]. Since the receptacle has a limited volume, when air or aerated water is being supplied to the receptacle through the tube [1], the excess water in the receptacle will exit through the relief spout [4]. The relief spout can be positioned to lead through the closure or lateral moving seal on one side of the receptacle. This embodiment allows the relief spout to move with the movement of the seal. This allows adjustments of the seal to be made laterally for various length animals in a limited volume of water. The seal can also be rotated so that the relief spout is, for example, on the top or on the bottom of the receptacle. Having the relief spout on the bottom of the receptacle can facilitate removal of waste material from the receptacle.

In some embodiments, the device further comprises a closure that can seal the opening in the receptacle. The opening must be large enough to allow for the placement and removal of the aquatic animal in the receptacle without harm to the aquatic animal. Most preferably, the opening comprises one side of the receptacle. For example, the opening can comprise, but is not limited to, the top or side of the receptacle. The closure [5] can be of any type known in the art. Preferably, the closure slides into the opening in the receptacle, allowing for the volume of the receptacle to be varied by varying the position of the closure. When the opening comprises the top of the receptacle, the closure can be a vertically moving closure. When the opening comprises a side of the receptacle, the closure can be a laterally moving closure. The closure can be made out of any material known in the art. Preferably, the closure is transparent to the method of imaging being used.

In some embodiments, the device further comprises a coil positioned around the receptacle for receiving and transmitting signals. Preferably, the coil comprises an electrically conductive metal connected to capacitors [9] which can receive signals such as magnetic resonance signals and transmit signals such as RF signals. This allows the device to be used for ultra-high resolution magnetic resonance imaging (MRI). Most preferably, the coil comprises an electrically conductive Metal cage comprised of electrically conductive metal strips [10] connected to each other by capacitors. Preferably, the coil closely fits around the receptacle and is removable, allowing flexibility in method of imaging used. The closely fitting coil results in a better MRI image than MRI imaging with a loosely-fitting coil.

In a preferred embodiment, the device comprises a tubular receptacle capable of holding an aquatic animal in a volume or water, a large opening in the rear of the receptacle, foam block restraints inside the receptacle to limit the movement of the aquatic animal, a tube for supplying air or aerated water with a physiological intervention port, a relief spout to allow equalization of excess gas or water pressure, and a laterally moving closure which can seal the large opening in the rear side of the receptacle.

The present invention also provides a method for immobilizing a live aquatic animal comprising placing an aquatic animal in a device comprising a receptacle for holding an aquatic animal in a volume of water, wherein the receptacle comprises an opening in the receptacle for placement and removal of the aquatic animal, a restraint positioned inside the receptacle for limiting movement of the aquatic animal, and a tube attached to the receptacle for supplying air or aerated water to the receptacle; and positioning the restraint inside the receptacle to limit the movement of the aquatic animal. Preferably, the animal is not paralyzed or anesthetized. In one embodiment, a bite plate can be positioned in the mouth of the animal to help protect the tube that delivers oxygen to the animal. The tube can be bifurcated to simultaneously provide oxygen to both gills of the animal. Wax, for example, or a similar material, can be used to seal the opening through which the tube passes into the receptacle.

The present invention further provides a method for imaging a live aquatic animal, the method comprising placing an aquatic animal in a device comprising a receptacle for holding an aquatic animal in a volume of water, an opening in the receptacle for placement and removal of the aquatic animal, a restraint positioned inside the receptacle for limiting movement of the aquatic animal, and a tube attached to the receptacle for supplying air or aerated water to the receptacle; positioning the restraint inside the receptacle to limit the movement of the aquatic animal; and imaging the aquatic animal.

The methods of imaging include any method known in the art including, but not limited to, positron emission tomography (PET), magnetic resonance imaging (MRI), ultra-high resolution magnetic resonance imaging, computed tomography (CT), or single photon emission computed tomography (SPECT). When the method of imaging is a high resolution method of imaging such as ultra-high resolution magnetic resonance imaging, a coil, preferably a closely fitting coil, for receiving and transmitting signals is placed around the receptacle before imaging.

Preferably, the animal is not paralyzed or anesthetized. In one embodiment, the method additionally comprises supplying air or aerated water to the receptacle once the aquatic animal has been placed inside. This allows for prolonged imaging studies without negative physiological effects on the aquatic animal. In other embodiments, fluids such as nutrients or drugs, electrodes for stimulating or monitoring, or optical monitoring scopes may be introduced to the receptacle before or during imaging. The method may also additionally comprise sealing the receptacle after immobilizing the aquatic animal inside the receptacle.

In a preferred embodiment, the method for imaging an aquatic animal comprises placing an aquatic animal and water in a receptacle, positioning a restraint inside the receptacle to limit the movement of the aquatic animal, sealing the receptacle, supplying air or aerated water to the aquatic animal in the receptacle, and imaging the aquatic animal.

The methods for immobilizing or for immobilizing and imaging a live aquatic animal can also involve using a laterally moving seal or closure on one side of the receptacle to reduce the volume of water around the animal once the animal has been placed inside the receptacle. The seal or closure can be fitted with a relief spout to remove excess gas and/or water. The seal or closure can be rotatable so that the relief spout can be positioned, for example, at the top of the receptacle or at the bottom of the receptacle.

1. A device for immobilizing an aquatic animal, the device comprising a receptacle for holding an aquatic animal in a volume of water, an opening in the receptacle for placement and removal of the aquatic animal, a restraint positioned inside the receptacle for limiting movement of the aquatic animal, and a tube attached to the receptacle for supplying air or aerated water to the receptacle.

2. The device of claim 1, wherein the receptacle comprises a physiological intervention port for supplying fluids, electrodes, or optical monitoring scopes into the receptacle.

3. The device of claim 1, wherein the device comprises a closure that can seal the opening in the receptacle.

4. The device of claim 1, wherein the device comprises a relief spout attached to the receptacle or to the closure to allow equalization of excess water or gas pressure.

5. The device of claim 4, wherein the relief spout is positioned though the closure and wherein the closure can be moved within the receptacle to reduce the volume of water surrounding the aquatic animal.

6. The device of claim 1, wherein the device comprises a bite plate for the aquatic animal.

7. The device of claim 1, wherein the tube for supplying air or aerated water is bifurcated to allow simultaneous delivery of oxygen to both gills of the aquatic animal.

8. The device of claim 1, wherein the device comprises a coil positioned around the receptacle for receiving and transmitting signals.

9. The device of claim 1, wherein the water is salt water.

10. The device of claim 1, wherein the water is fresh water.

11. The device of claim 1, wherein the aquatic animal is a fish.

12. The device of claim 1, wherein the aquatic animal is a crustacean.

13. The device of claim 1, wherein the aquatic animal is a cephalopod.

14. A method for immobilizing a live aquatic animal comprising
placing an aquatic animal in a device comprising a receptacle for holding an aquatic animal in a volume of water, wherein the receptacle comprises an opening in the receptacle for placement and removal of the aquatic animal, a restraint positioned inside the receptacle for limiting movement of the aquatic animal, and a tube attached to the receptacle for supplying air or aerated water to the receptacle; and
positioning the restraint inside the receptacle to limit the movement of the aquatic animal.

15-17. (canceled)

18. A method for imaging a live aquatic animal, the method comprising
placing an aquatic animal in a device comprising a receptacle for holding an aquatic animal in a volume of water, wherein the receptacle comprises an opening in the receptacle for placement and removal of the aquatic animal, a restraint positioned inside the receptacle for limiting movement of the aquatic animal, and a tube attached to the receptacle for supplying air or aerated water to the receptacle;
positioning the restraint inside the receptacle to limit the movement of the aquatic animal; and
imaging the aquatic animal.

19. The method of claim 18, wherein the method comprises supplying air or aerated water to the receptacle once the aquatic animal has been placed inside.

20. The method of claim 19, wherein the air or aerated water is supplied using a bifurcated tube that allows simultaneous delivery of oxygen to both gills of the aquatic animal.

21. The method of claim 18, wherein the device comprises a bite plate for the aquatic animal.

22. The method of claim 18, wherein the method comprises sealing the receptacle after immobilizing the aquatic animal inside the receptacle.

23. The method of claim 22, wherein the method comprises reducing the volume of the sealed receptacle to reduce the volume of water surrounding the aquatic animal.

24-36. (canceled)
